(19) United States
(12) Patent Application Publication
(10) Pub. No.: US 2005/0082778 A1
(43) Pub. Date: Apr. 21, 2005

(54) Cambering vehicle having resilient coupling

(76) Inventor: Jin Chen Chuang, Taichung (TW)

Correspondence Address: Jin Chen Chuang, P.O. Box 63-99, Taichung, 406, TW

(21) Appl. No.: 10/689,492

(22) Filed: Oct. 17, 2003

(51) Int. Cl. B62M 1/00

(52) U.S. Cl. 280/87.041

(57) ABSTRACT

A cambering vehicle includes a front column, a left and a right trailing arm each having a front portion pivotally attached to the front column and a rear wheel. A link includes two ends coupled to the trailing arms and an intermediate portion coupled to the front column, to allow the trailing arms to be operated by the front column. The front column includes an extension coupled to the link. The link includes three resiliently supported barrels coupled to the trailing arms and the extension of the front column with pins respectively, to resiliently couple the trailing arms and the front column together.

### BACKGROUND OF THE INVENTION

1. Field of the Invention

The present invention relates to a cambering vehicle, and more particularly to a cambering vehicle having a resilient coupling.

2. Description of the Prior Art

Various kinds of typical cambering vehicles have been developed as operator propelled three wheeled vehicle, and comprise a front column having a steering shaft rotatably attached thereto, a front wheel attached to bottom of the steering shaft, and a pair of laterally spaced rear wheels on trailing arms which are articulated to the front column.

As the vehicle travels a sinusoidal path, the operator shifts his or her weight to the inside of each turning arc, to shift the center of mass to the inside of each arc, and to result a series of accelerations due to the conservation of momentum of the vehicle and operator, and thus to attain a forward motion.

For example, U.S. Pat. No. 4,123,079 to Biskup discloses one of the typical cambering vehicles including two trailing arms resiliently interconnected together by a torsion bar between the two trailing arm pivot axles, and including another embodiment having resilient trailing arms. However, the torsion bar may not be used to solidly coupling the handlebar and the trailing arms together.

U.S. Pat. No. 4,133,551 to Biskup discloses another typical cambering vehicle including a crank arm having oppositely offset cranks which ride in slots in the opposite trailing arms. Again, the crank arm is provided for connecting the opposite trailing arms together, but also may not be used to solidly coupling the trailing arms to the handlebar.

U.S. Pat. No. 5,039,121 to Holter discloses a further typical cambering vehicle including two opposite trailing arms immovably affixed to the front structure during operation. A crossmember is pivotally connected between the opposite trailing arms. Similarly, no coupling devices may be used to solidly coupling the trailing arms to the handlebar.

U.S. Pat. No. 6,220,612 to Beleski, Jr., and U.S. Pat. No. 6,467,781 to Feng disclose two other typical cambering vehicles including a yoke arm having two yoke bars engaged on top and bottom of the opposite trailing arms. The yoke bars may be provided for connecting the opposite trailing arms together, but also may not be used to solidly coupling the trailing arms to the handlebar.

U.S. Pat. No. 6,467,986 to Feng, and U.S. Pat. No. 6,517,093 to Feng, disclose two further typical cambering vehicles including two opposite trailing arms each having a foldable structure and lockable with a complicated locking structure. Similarly, no coupling devices may be used to solidly coupling the trailing arms to the handlebar.

U.S. Pat. No. 6,554,302 to Liu discloses a still further typical cambering vehicle including two trailing arms coupled to a handlebar with two side plates, a lashing seat, and a connecting rod. Each of the opposite trailing arms includes a foldable structure. However, similarly, no coupling devices may be used to solidly coupling the trailing arms to the handlebar.

U.S. Pat. No. 6,499,751 to Beleski, Jr. discloses a still further typical cambering vehicle including a yoke arm having two yoke bars engaged on top and bottom of the opposite trailing arms, and a lateral link engaged into and coupled to the opposite trailing arms. However, both the yoke bars and the lateral link may only be provided for connecting the opposite trailing arms together, but also may not be used to solidly coupling the trailing arms to the handlebar.

The present invention has arisen to mitigate and/or obviate the afore-described disadvantages of the conventional cambering vehicles.

### SUMMARY OF THE INVENTION

The primary objective of the present invention is to provide a cambering vehicle including a link coupled between the trailing arms and the handle bar, for pivotally connecting the trailing arms to the handle bar, and for facilitating the operation of the trailing arms by the handlebar.

The other objective of the present invention is to provide a cambering vehicle including a structure for allowing the trailing arms of the cambering vehicle to be folded to a compact configuration.

In accordance with one aspect of the invention, there is provided a cambering vehicle comprising a front column for supporting a front wheel, a left and a right trailing arm each including a front portion pivotally attached to the front column, and each including a rear portion having a rear wheel attached thereto, and each including a foot pedal disposed thereon to support users, and a link including two ends coupled to the left and the right trailing arms respectively, and including an intermediate portion coupled to the front column, to allow the left and the right trailing arms to be operated by the front column.

The front column includes an extension extended therefrom and coupled to the intermediate portion of the link. The extension of the front column includes at least one ear extended therefrom and pivotally coupled to the intermediate portion of the link with a pin. Each of the left and the right trailing arms includes at least one ear extended therefrom and pivotally coupled to the ends of the link with pins respectively.

The link includes three barrels provided in the intermediate portion and the ends thereof, to receive the pins respectively, and includes three housings to receive the barrels in the housings, and a resilient member coupled between the housing and the barrel respectively, to resiliently support the barrel in the housing. The resilient member of the link includes a sleeve engaged around the barrel, and at least one rib coupled between the sleeve and the housing.

It is preferable that the extension of the front column is pivotally coupled to the intermediate portion of the link with a pin which includes a non-circular cross section, to allow the trailing arms to be operated by the front column.

The front column includes a front tube, a steering shaft rotatably disposed concentrically within the front tube, the front wheel is provided on bottom of the steering shaft, and a handle provided on top of the steering shaft.

Each of the left and the right trailing arms includes a front segment pivotally attached to the front column, and a rear segment pivotally secured to the front segment thereof, to allow the rear segment to be rotated relative to the front segment thereof. Each of the left and the right trailing arms includes a latch to lock the front segment and the rear segment thereof together.

Each of the front segments of the left and the right trailing arms includes a projection having a recessed seat formed therein, and each of the latches includes a catch to selectively engage in the recessed seat of the projection, and to lock the front segment and the rear segment thereof together.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a cambering vehicle in accordance with the present invention;

FIG. 2 is an enlarged partial perspective view illustrating a link of the cambering vehicle for coupling the handlebar and the trailing arms together;

FIG. 3 is an enlarged partial exploded view illustrating the coupling of the link with the trailing arms and the handle of the cambering vehicle;

FIG. 4 is a top plan view of the link;

FIG. 5 is a front plan view of the link;

FIGS. 6, 7 are cross sectional views taken along lines 6-6 and 7-7 of FIG. 5 respectively;

FIG. 8 is a side plan view of the cambering vehicle; and

FIG. 9 is a side plan view of the cambering vehicle, similar to FIG. 8, illustrating the folding operation of the cambering vehicle.

### DETAILED DESCRIPTION OF THE PREFERRED EMBODIMENT

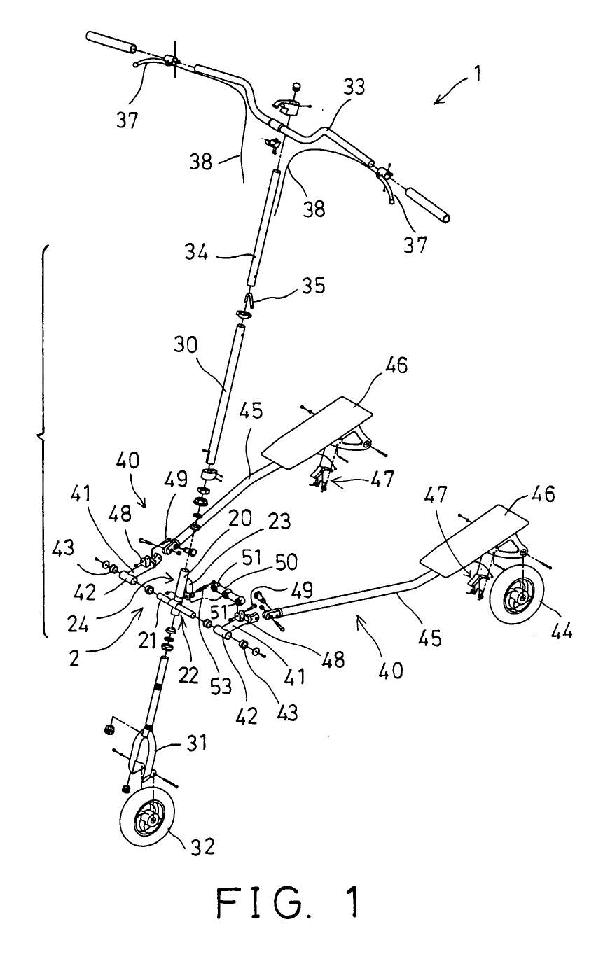

Referring to the drawings, and initially to FIGS. 1, 2, 8, and 9, a cambering vehicle 1 in accordance with the present invention comprises a front column 2 including a front tube 20, a steering shaft 30 rotatably engaged or disposed concentrically within the front tube 20, a front fork 31 attached to bottom of the steering shaft 30 to support a front wheel 32, and a handle 33 supported on top of the steering shaft 30.

The steering shaft 30 may further include a stem 34 retractably received therein and extendible outwardly therefrom, or adjustably secured to the steering shaft 30 with such as a quick release clamp 35. The handle 33 is secured on top of the steering shaft 30 or on top of the stem 34 of the steering shaft 30. One or more, such as two brake hand grips 37 are attached to the handle 33 for braking purposes, and are coupled to cables 38 respectively.

The front column 2 includes an axle 21 attached to or extended from the front tube 20, such as attached to the front and lower portion 22 of the front tube 20, and includes a curved extension 23 extended rearwardly and downwardly from the upper portion 24 of the front tube 20.

A left trailing arm and a right trailing arm 40 each include a front segment 41 rotatably or pivotally attached to the front tube 20 or the front column 2 with the pivot axle 21 respectively. For example, each of the trailing arms 40 includes a bushing 42 attached or provided on the front portion thereof, and rotatably attached onto the pivot axle 21, for rotatably or pivotally coupling the trailing arms 40 to the front tube 20 or the front column 2 with the pivot axle 21.

The front segments 41 or the bushings 42 of the trailing arms 40 may be rotatably attached to the pivot axle 21 with washers, gaskets, bearings 43 or the like, for allowing the front segments 41 or the bushings 42 of the trailing arms 40 to be rotatably coupled to the front tube 20. Each of the trailing arms 40 includes a rear wheel 44 rotatably attached to a rear portion or a rear segment 45 thereof, and a foot pedal 46 disposed on the rear portion or the rear segment 45 of the trailing arms 40 to support users.

The cambering vehicle 1 may further include two brake devices 47 attached to the rear portions or the rear segments 45 of the trailing arms 40 respectively, for braking the rear wheels 44 respectively. The brake hand grips 37 are coupled to the brake devices 47 with the cables 38 respectively, in order to actuate the brake devices 47 to brake the rear wheels 44.

Each of the trailing arms 40 includes a bracket or one or more, such as two ears 48 secured thereto or extended therefrom, such as secured to or extended from the front segment 41 of the trailing arms 40 respectively, and preferably extended upwardly from the front segments 41 of the trailing arms 40. However, alternatively, the ears 48 of the trailing arms 40 may also be extended laterally from the trailing arms 40 respectively, and face toward each other.

A link 50 includes two ends 51 pivotally or rotatably secured to the trailing arms 40, such as pivotally or rotatably secured to the ears 48 of the trailing arms 40 with fasteners or pins 49 and/or gaskets or bearings (not shown) or the like. The link 50 includes a middle or intermediate portion 52 pivotally or rotatably secured to the extension 23 of the front tube 20 of the front column 2 with a fastener or pin 53, such that the link 50 may couple the trailing arms 40 and the front tube 20 or the front column 2 together.

For example, the extension 23 of the front tube 20 of the front column 2 includes a bracket or one or more, such as two ears 25 secured thereto or extended therefrom, such as secured to or extended from the lower or free end thereof, for receiving or attaching to the middle or intermediate portion 52 of the link 50 with the fastener or pin 53.

As shown in FIGS. 2-7, the link 50 includes three housings 54 formed or provided in the ends 51 and the intermediate portion 52 thereof respectively, three barrels 55, 56 received in the housings 54 respectively, and three resilient members 57 coupled between the barrels 55, 56 and the housings 54 respectively, to resiliently supporting the barrels 55, 56 within the housings 54 respectively, or to provide a resilient or cushioning force between the barrels 55, 56 and the housings 54 respectively.

For example, each of the resilient members 57 includes a sleeve 58 engaged around the barrels 55, 56 respectively, and one or more ribs 59 coupled between the sleeve 58 and the housings 54 respectively, to resiliently supporting the barrels 55, 56 within the housings 54 respectively. The resilient members 57 are preferably made of resilient metal or rubber or synthetic materials. The pins 49, 53 are engaged in the barrels 55, 56 respectively such that the pins 49, 53 and the ears 48, 25 may also be resiliently coupled to the housings 54 of the link 50 respectively.

It is preferable that the barrel 56 and the pin 53 include a non-circular cross section, such as a square or a rectangular cross section, for mating with each other, and for preventing the pin 53 from rotating relative to the barrel 56, and for allowing the barrel 56 and the pin 53 to be rotated or twisted relative to the housings 54 of the link 50 against the resilient members 57. The resilient members 57 may thus recover the barrel 56 and the pin 53 back to the original position relative to the housings 54 of the link 50 after the barrel 56 and the pin 53 are released.

In operation, when the vehicle travels a sinusoidal path, and when the operator shifts his or her weight to the inside of each turning arc, to shift the center of mass to the inside of each arc, the front column 2 may thus be tilted relative to the ground, to result a series of accelerations due to the conservation of momentum of the vehicle and operator, and thus to attain a forward motion. In addition, when the link 50 is rotated relative to the extension 23 of the front column 2 about the pin 53, the resilient members 57 may apply a spring biasing force to recover the housings 54 of the link 50 back to the original position relative to the barrel 56 and the pin 53.

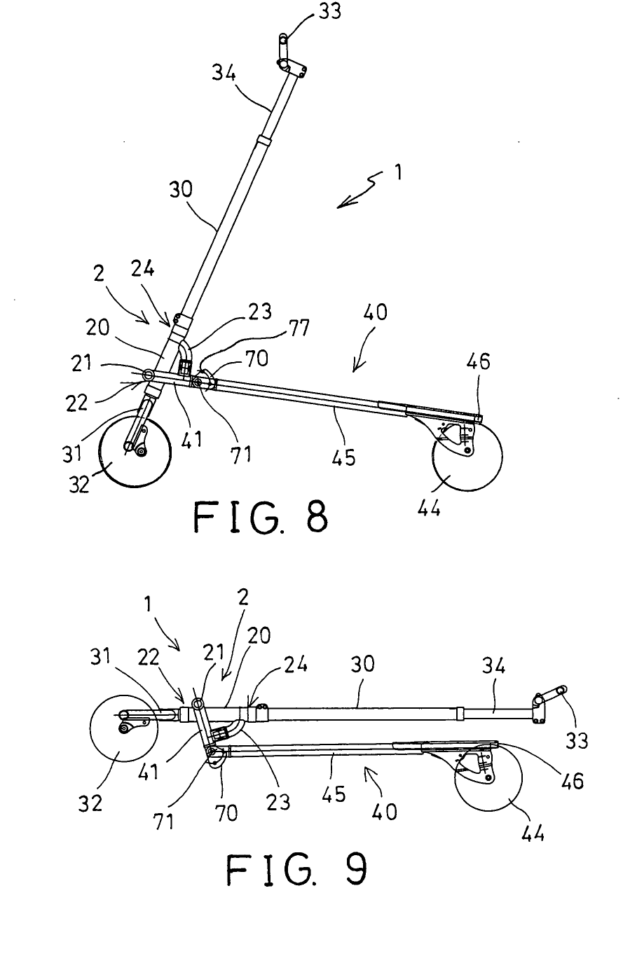

It is preferable that each of the trailing arms 40 includes a foldable structure for allowing the trailing arms 40 to be folded toward and away from the steering shaft 30 or the front column 2, best shown in FIGS. 8 and 9, and to be folded between a downward working position as shown in FIG. 8, and an upward folding or storing position as shown in FIG. 9.

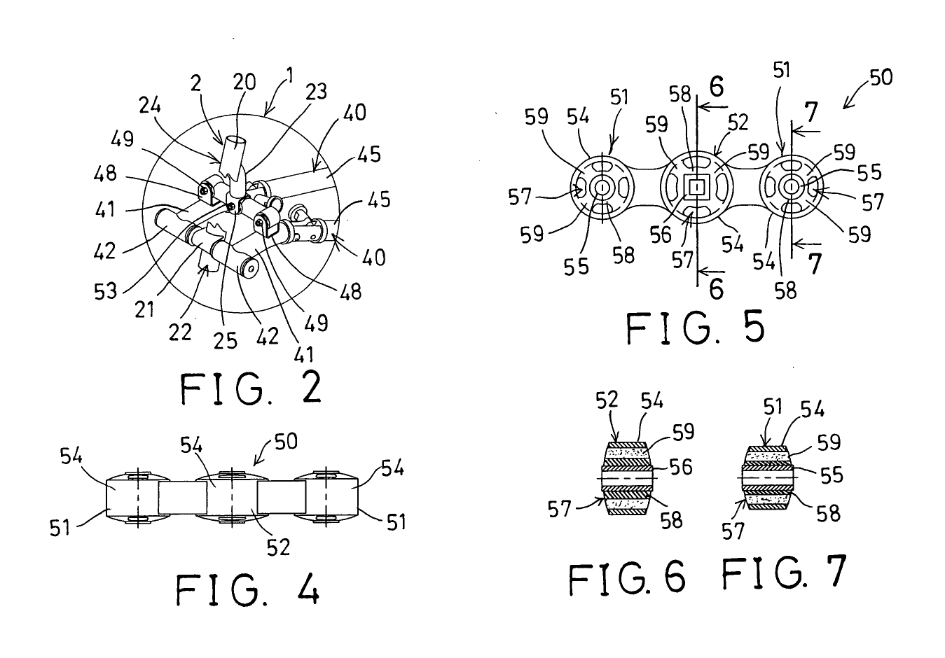

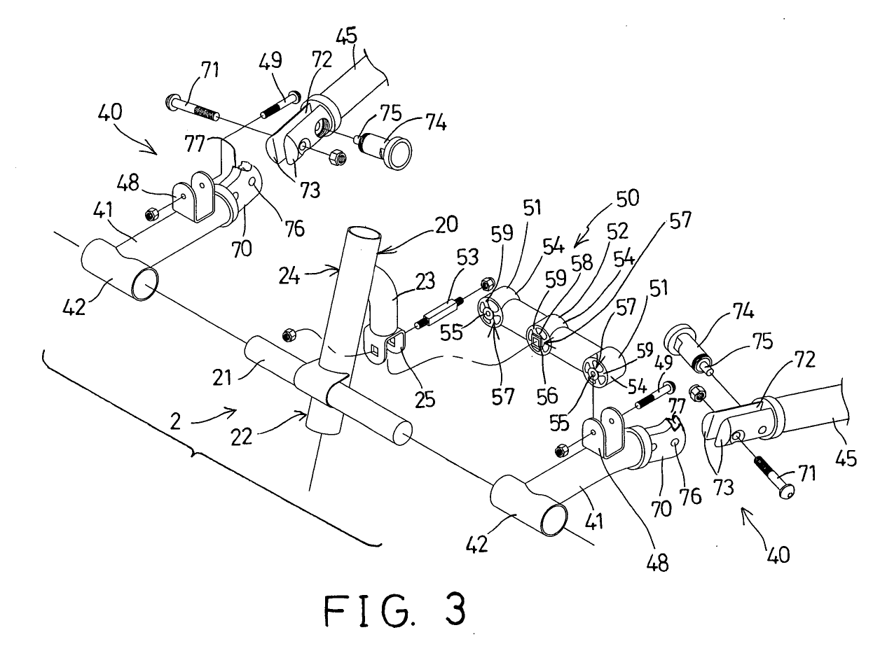

As shown in FIGS. 2 and 3, each of the front segments 41 of the trailing arms 40 includes a projection 70 extended therefrom, and pivotally or rotatably coupled to the rear segment 45 of the trailing arms 40 with a pivot rod 71, to allow the rear segment 45 to be folded or rotated relative to the front segments 41 of the trailing arms 40, and to be rotated or folded toward and away from the steering shaft 30 or the front column 2, as shown in FIGS. 8 and 9.

For example, the rear segment 45 of the trailing arms 40 includes a channel 72 defined between two bars 73, to rotatably receive the projection 70 of the front segments 41. A latch 74, such as a spring-biased latch 74 is attached to either of the bars 73, and includes a catch 75 for locking the front segments 41 and the rear segments 45 of the trailing arms 40 together.

For example, the catch 75 of the latch 74 may be extended into the channel 72 of the rear segment 45 of the trailing arms 40, and engageable into an orifice 76 of the projection 70 of the front segments 41 of the trailing arms 40, in order to lock the front segments 41 and the rear segment 45 of the trailing arms 40 together and in line with each other, and thus to maintain the rear segment 45 at the downward working position, as shown in FIG. 8, relative to the front segments 41 of the trailing arms 40, and thus to retain the vehicle in a tricycle-shaped cambering vehicle.

Each of the projections 70 of the front segments 41 of the trailing arms 40 includes a recessed seat 77 to selectively receive the catch 75 of the latch 74 when the rear segment 45 is rotated relative to the front segments 41 of the trailing arms 40 to the upward folding or storing position as shown in FIG. 9, or folded toward the steering shaft 30 or the front column 2, in order to maintain the rear segment 45 at the folding position, as shown in FIG. 9, relative to the front segments 41 of the trailing arms 40, and thus to retain the vehicle in a compact folding structure.

It is to be noted that none of the typical cambering vehicles suggested to provide a link 50 that may be coupled between the trailing arms 40 and that may be simultaneously coupled to the extension 23 of the front tube 20 of the front column 2. The coupling of the extension 23 of the front tube 20 of the front column 2 to the link 50 allows the front tube 20 of the front column 2 and the handle 33 and the steering shaft 30 to apply forces against the link 50 and thus the trailing arms 40, and thus allows the trailing arms 40 to be operated by the front tube 20 of the front column 2 and the handle 33 and the steering shaft 30.

Accordingly, the cambering vehicle includes a link coupled between the trailing arms and the handle bar, for pivotally connecting the trailing arms to the handle bar, and for facilitating the operation of the trailing arms by the handlebar, and includes a structure for allowing the trailing arms to be folded to a compact configuration.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A cambering vehicle comprising:
a front column for supporting a front wheel,
a left and a right trailing arm each including a front portion pivotally attached to said front column, and each including a rear portion having a rear wheel attached thereto, and each including a foot pedal disposed thereon to support users, and
a link including two ends coupled to said left and said right trailing arms respectively, and including an intermediate portion coupled to said front column, to allow said left and said right trailing arms to be operated by said front column.

2. The cambering vehicle as claimed in claim 1, wherein said front column includes an extension extended therefrom and coupled to said intermediate portion of said link.

3. The cambering vehicle as claimed in claim 2, wherein said extension of said front column includes at least one ear extended therefrom and pivotally coupled to said intermediate portion of said link with a pin.

4. The cambering vehicle as claimed in claim 3, wherein said link includes a barrel provided in said intermediate portion thereof, to receive said pin.

5. The cambering vehicle as claimed in claim 4, wherein said link includes a housing provided in said intermediate portion thereof, to receive said barrel in said housing.

6. The cambering vehicle as claimed in claim 5, wherein said link includes a resilient member coupled between said housing and said barrel, to resiliently support said barrel in said housing.

7. The cambering vehicle as claimed in claim 6, wherein said resilient member of said link includes a sleeve engaged around said barrel, and at least one rib coupled between said sleeve and said housing.

8. The cambering vehicle as claimed in claim 3, wherein said pin includes a non-circular cross section.

9. The cambering vehicle as claimed in claim 1, wherein each of said left and said right trailing arms includes at least one ear extended therefrom and pivotally coupled to said ends of said link with pins respectively.

10. The cambering vehicle as claimed in claim 9, wherein said link includes a barrel provided in each of said ends thereof, to receive said pins respectively.

11. The cambering vehicle as claimed in claim 10, wherein said link includes a housing provided in each of said ends thereof, to receive said barrels in said housings respectively.

12. The cambering vehicle as claimed in claim 11, wherein each of said housings includes a resilient member coupled between said housing and said barrel, to resiliently support said barrel in said housing.

13. The cambering vehicle as claimed in claim 12, wherein each of said resilient members includes a sleeve engaged around said barrel, and at least one rib coupled between said sleeve and said housing respectively.

14. The cambering vehicle as claimed in claim 1, wherein said front column includes a front tube, a steering shaft rotatably disposed concentrically within said front tube, said front wheel is provided on bottom of said steering shaft, and a handle provided on top of said steering shaft.

15. The cambering vehicle as claimed in claim 1, wherein each of said left and said right trailing arms includes a front segment pivotally attached to said front column, and a rear segment pivotally secured to said front segment thereof, to allow said rear segment to be rotated relative to said front segment thereof.

16. The cambering vehicle as claimed in claim 15, wherein each of said left and said right trailing arms includes a latch to lock said front segment and said rear segment thereof together.

17. The cambering vehicle as claimed in claim 16, wherein each of said front segments of said left and said right trailing arms includes a projection having a recessed seat formed therein, and each of said latches includes a catch to selectively engage in said recessed seat of said projection, and to lock said front segment and said rear segment thereof together.
